(19) United States
(12) Patent Application Publication
(10) Pub. No.: US 2009/0137308 A1
(43) Pub. Date: May 28, 2009

(54) METHOD OF GAMING AND A GAMING SYSTEM

(75) Inventor: Philip Jeffery Anderson, Las Vegas, NV (US)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY LIMITED, Lane Cove NSW (AU)

(21) Appl. No.: 12/143,482

(22) Filed: Jun. 20, 2008

Related U.S. Application Data
(60) Provisional application No. 60/945,719, filed on Jun. 22, 2007.

(51) Int. Cl. A63F 9/24; A63F 13/00

(52) U.S. Cl. 463/20; 463/40

(57) ABSTRACT

A gaming system has a display (54). A player hand selector (623) is arranged to select a plurality of symbols to form a player hand for display on the display (54). A symbol selector (561) is operable by a player to select one or more symbols of the player hand. A hand display modifier (622) is arranged to modify the display of at least part of the player hand so that the size of each selected symbol is different to each non-selected symbol to assist a player to distinguish selected and non-selected symbols within the player hand.

### RELATED APPLICATIONS

This application claims priority to U.S. Provisional Patent Application No. 60/945,719, having a filing date of Jun. 22, 2007, entitled “Method of Gaming And A Gaming System,” which is hereby incorporated by reference herein in its entirety.

### FIELD OF THE INVENTION

The present invention relates to a method of gaming, the gaming system and a player interface for a gaming system.

### BACKGROUND OF THE INVENTION

In some games, particularly games of skill, players are required to make a selection of displayed symbols as part of game play. In some games, if a player proceeds to a next stage of game having made an erroneous selection of symbols, there can be an adverse impact on the outcome of the game.

### BRIEF SUMMARY OF THE INVENTION

[In a first aspect the invention provides method of gaming comprising:
displaying to a player, a player hand comprising a plurality of symbols;
receiving a player selection of one or more symbols of the player hand; and
modifying the display of at least part of the player hand so that the size of each selected symbol is different to each non-selected symbol to assist a player to distinguish selected and non-selected symbols within the player hand.

In an embodiment, the method comprises modifying display of the selected symbols.

In an embodiment, the method comprises modifying display of the non-selected symbols.

In an embodiment, modifying the display of the symbols further comprises changing another visual characteristic of the symbols. For example color, shape or any other visual characteristic of the symbols.

In an embodiment, the symbols are playing cards.

In an embodiment, the selected and non-selected cards are modified to alter the display of held cards relative to discard cards in a poker game.

In a second aspect, the invention provides a gaming system comprising:
a display;
a player hand selector arranged to select a plurality of symbols to form a player hand for display on the display;
a symbol selector operable by a player to select one or more symbols of the player hand; and
a hand display modifier arranged to modify the display of at least part of the player hand so that the size of each selected symbol is different to each non-selected symbol to assist a player to distinguish selected and non-selected symbols within the player hand.

In an embodiment, the hand display modifier is arranged to modify display of the selected symbols.

In an embodiment, the hand display modifier is arranged to modify display of the non-selected symbols.

In an embodiment, the hand display modifier is arranged to modify the display of the symbols by changing another visual characteristic of the symbols.

In an embodiment, the visual characteristic is one or both of color or shape.

In an embodiment, the symbols are playing cards.

In an embodiment, the selected and non-selected cards are modified to alter the display of held cards relative to discard cards in a poker game.

In an embodiment, the gaming system comprises a processor and a memory storing program code which when executed by the processor implements the player hand selector and the hand display modifier.

In an embodiment, the symbol selector comprises at least one of a touch screen and one or more buttons.

In a third aspect, the invention provides a player interface for a gaming system comprising:
a display arranged to display a player hand comprising a plurality of symbols forming a player hand; and
a symbol selector operable by a player to select one or more symbols of the player hand,
whereafter display of at least part of the player hand is modified so that the size of each selected symbol is different to each non-selected symbol to assist a player to distinguish selected and non-selected symbols within the player hand.

In a fourth aspect, the invention provides computer program code which when executed by a computer implements a computer implemented method of gaming comprising:
displaying to a player, a player hand comprising a plurality of symbols;
receiving a player selection of one or more symbols of the player hand; and
modifying the display of at least part of the player hand so that the size of each selected symbol is different to each non-selected symbol to assist a player to distinguish selected and non-selected symbols within the player hand.

The invention also provides a computer readable medium comprising the above program code.

The invention also provides a data signal comprising the above program code.

The invention also extends to transmitting the above program code.

### BRIEF DESCRIPTION OF SEVERAL VIEWS OF THE DRAWINGS

FIG. 1 is a block diagram of the functional components of a gaming system;

FIG. 2 is a perspective view of a gaming system in the form of an electronic gaming machine;

FIG. 3 is a block diagram of a gaming machine;

FIG. 4 is a block diagram of a gaming machine;

FIG. 5 is a block diagram of the components of a gaming system having a distributed architecture;

FIG. 6 is a block diagram of functional components of a gaming system of the embodiment;

FIG. 7 is a flow chart of a gaming method of the embodiment; and

FIGS. 8a to 8c are exemplary of screen shots of an example.

### DETAILED DESCRIPTION OF THE INVENTION

Referring to the drawings, there is shown a gaming system arranged to implement a game wherein the display of selected symbols is modified relative to non-selected symbols. In an embodiment, the gaming system shows which cards are held in a video poker game. The gaming system can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

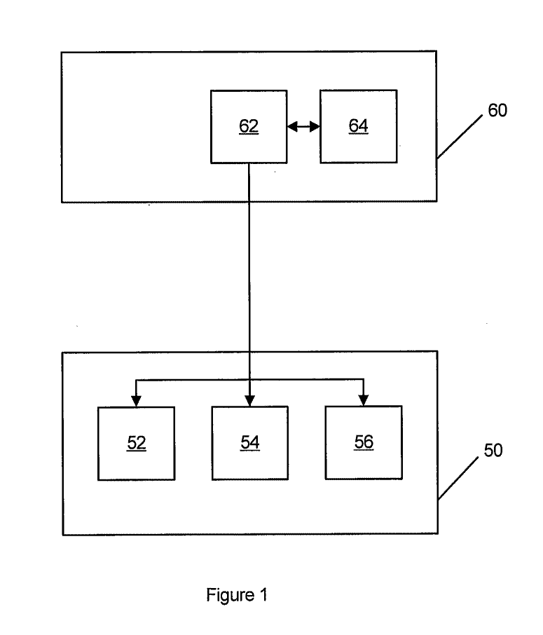

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

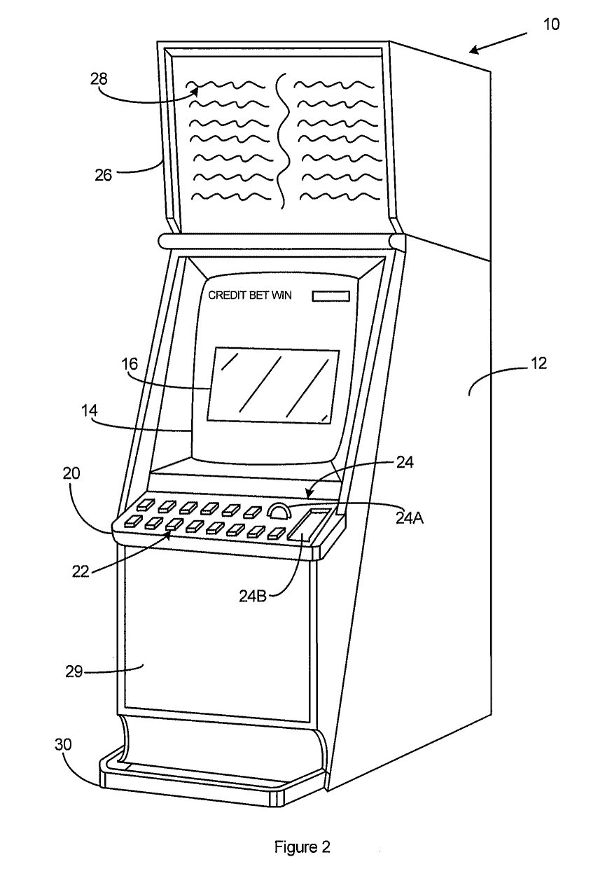

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

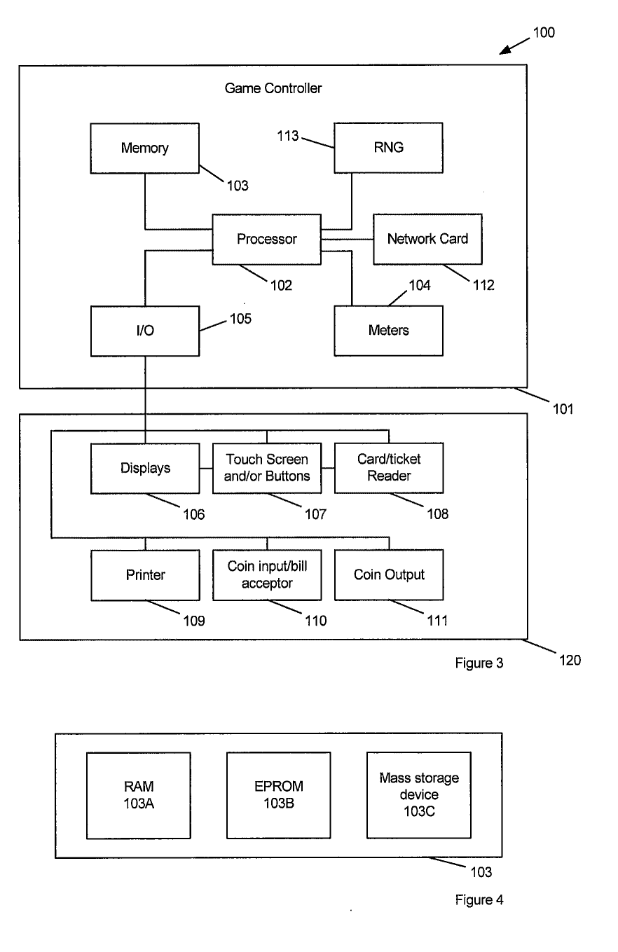

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 have one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

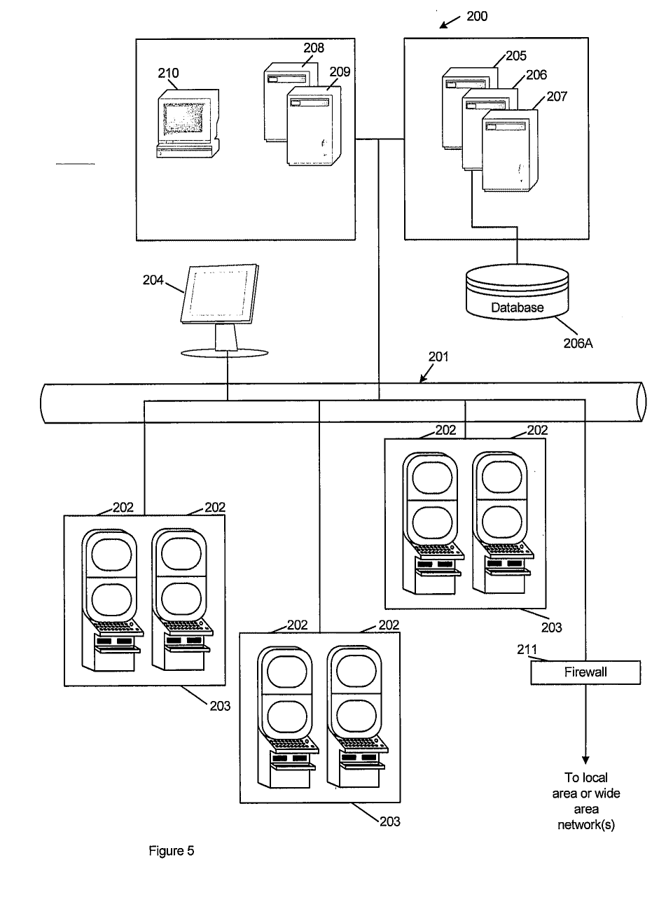

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

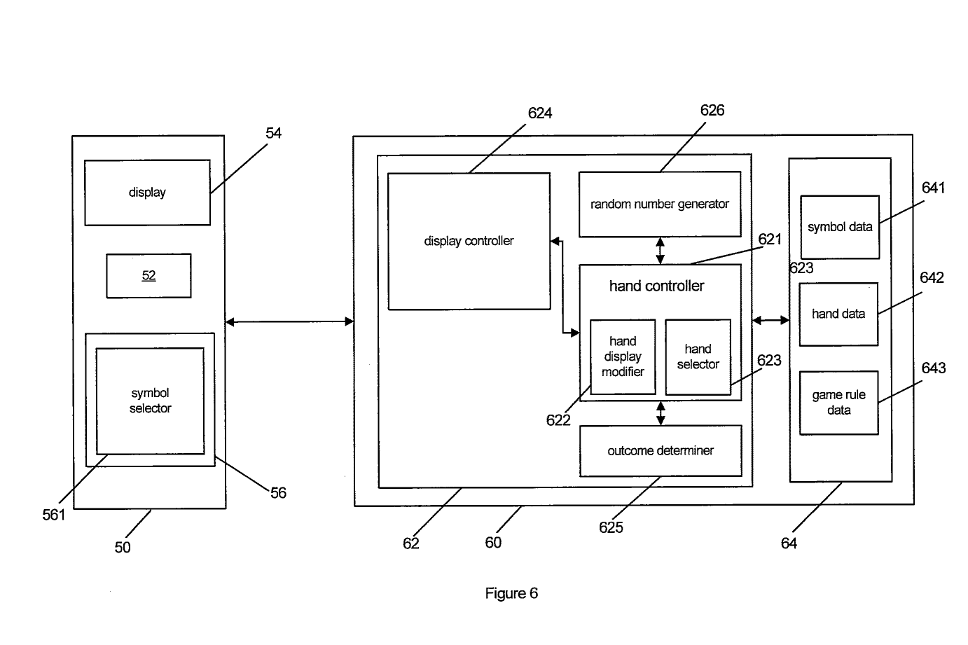

The gaming system of the embodiment is shown in more detail in the functional block diagram of FIG. 6. In accordance with the normal manner of play of gaming machines, a player obtains credits using the credit mechanism 52. The player operates the game play mechanism 56 to indicate that they wish to play a game. In response to a player indicating that they want to play a game, the hand controller 621 which is implemented by processor 62 begins operation. A player hand selector 623 of the hand controller 621 employs the random number generator 626 to randomly select a hand of symbols based on a set of symbols stored as symbol data 641. In a typical game of this type there will be a fixed set of symbols from which a player can obtain symbols. The selected hand is then stored by the hand controller as hand data 642. Hand controller 621 then provides data specifying the hand of symbols to the display controller 624 which controls the display 54 to display the hand of symbols to the player. Persons skilled in the art will appreciated that while the above embodiment describes an implementation employing a processor to execute code stored in memory 64 to implement various components 621,625,624,626 of the game controller 60, in other embodiments some or all of these components could be implemented by a dedicated circuit.

The player reviews the hand and, based on their knowledge of the game rules, or optionally based on suggestions provided by the game controller 60, selects one or more of the symbols by operating the symbol selector 561. Typically the symbol selector 561 is formed by a touch screen 107 which allows the player to select individual symbols of the hand which is displayed by touching the symbols on the display 56. The output of the touch screen is transmitted to the game controller 60 which processes the touch screen output to determine which symbols have been selected by the symbol selector 561. The symbol selector 561 can be a series of buttons in lieu of or in addition to a touch display screen as is known in the art.

A hand display modifier 622 of the hand controller 621 updates the hand data 642 to indicate which symbols have been selected and causes the display controller 624 to change the appearance, e.g. size, of the display of the selected symbols relative to the non selected symbols on display 54. Typically this size is changed by making the selected symbols larger. However, it will be appreciated that the relative size of the selected symbols could also be made smaller or the size of both selected and non-selected symbols altered to thereby change the relative size of the symbols depending on the specific rules specified in game rule data 642. Typically in such a game once the player has made the selection they complete play of the game by touching a “Draw” icon or button on the gaming machine which forms part of game play mechanism 56.

An advantage of an embodiment, is that by changing the relative size of the display, the player can more readily determine whether they have made a correct symbol selection. Further processing following the selection of the symbols will depend on the particular type of game that is being played. For example, some embodiments the hand selector 623 may select, further symbols 641 to replace the non-selected symbols such as in the game of Video Poker. A person skilled in the art will appreciate that while it has been described above that the symbol selected by the player are kept or “held” by the player, the player selected symbols could also be discarded and replaced.

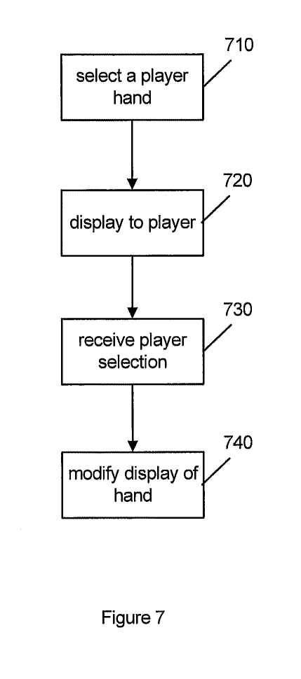

FIG. 7 shows a flow chart of the embodiment. The gaming system selects a player hand 710. The player hand is displayed to the player 720. A player selection is received 730 and the display of the hand is modified 740.

### EXAMPLE

In the example, the symbols are playing cards and the game is a Video Poker game of the type where a player makes a selection as to what cards to keep or “hold” and as to what cards are discarded and replaced under the rules of the game. That is, for each card that is discarded, the hand selector 623 will select a replacement card. Typically the symbol data will define symbols corresponding to one or more decks of cards. The hand selector 623 randomly selects a hand of cards for the player which is displayed on display 54. The player operates the touch screen (or buttons) to select which cards they wish to hold. The unselected cards represent the cards they wish to replace (or discard).

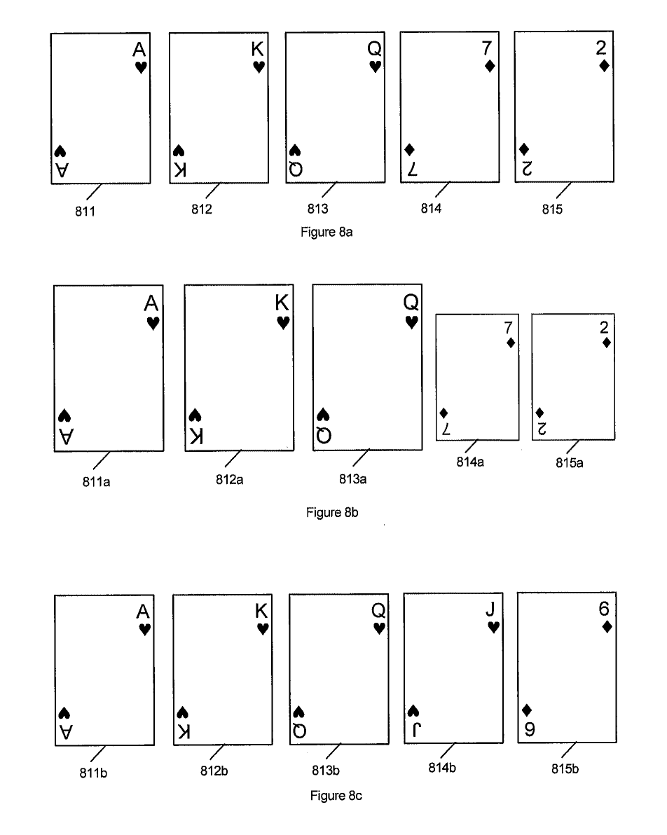

FIG. 8a shows an exemplary hand 810 where a player has received the Ace 811, King 812 and Queen 813 of hearts. The player has also received a seven of diamonds 814 and a two of diamonds 815. The player operates the touch screen which forms part of a symbol selector 561 in order to select the Ace, King and Queen of hearts as held cards by touching those symbols. The non-selected seven of diamonds, two of diamonds 814,815 are to be replaced. FIG. 8b shows an exemplary display after the player has made these selections with a modified hand 810a where the Ace 811a, King 812a and Queen 813a have been enlarged in size, while the size of the 7 of diamonds and 2 of diamonds 814a and 815a is the same. It will apparent that it is easy for the player to see which cards have been selected as they are larger. After making these selections, the player confirms the selection by operating game play mechanism 56, for example by pressing a button, and thereby controls the hand selector 623 to select and display replacement symbols from symbol data 641 for the seven of diamonds and the two of diamonds and updates the hand data 642. In this game, the player only obtains a single opportunity to modify the hand and therefore the game outcome is also determined based on the revised hand data 642 represented by the displayed hand 810b of FIG. 8c and the game rule data 643 to determine what prize, if any is awarded to the player. In another embodiment, the player may be allowed additional selections or to make additional selections if a condition is met, such as an additional wager being made. Therefore, it will be seen that in final hand 810b the seven of diamonds and two of diamonds of hand 814a,815a have been replaced with a Jack of hearts 814b and a six of diamonds 815b respectively and the outcome will be determined based on these cards.

Persons skilled in the art will appreciate that embodiments of the invention can be extended to games where a player plays multiple hands simultaneously. In such an embodiment a player may select held cards for each hand such that when that hand the relative size of the held cards is changed.

Persons skilled in the art will appreciate that embodiments of the present invention can also be implemented on gaming machines in other forms. For example, on a multiplayer gaming table such as is described it United States Publication 2006/055114 assigned to Pokertek, Inc where each player has there own play area would have the display of cards modified. In such an embodiment a player's play area would have the display of cards modified.

Persons skilled in the art will appreciate that additional visual characteristics such as color can be altered in addition to size to enhance an indication of a selected card.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading the program code from a server so that it is transmitted to the game controller).

Other modifications and variations will be apparent to persons skilled in the art and should be understood as falling within the scope of the invention described herein. In particular, persons skilled in the art will appreciate that features of the above embodiments and example can be employed to form further embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming comprising:
displaying to a player, a player hand comprising a plurality of symbols;
receiving a player selection of one or more symbols of the player hand; and
modifying the display of at least part of the player hand so that the size of each selected symbol is different to each non-selected symbol to assist a player to distinguish selected and non-selected symbols within the player hand.

2. A method as claimed in claim 1, comprising modifying display of the selected symbols.

3. A method as claimed in claim 1, comprising modifying display of the non-selected symbols.

4. A method as claimed in claim 1, wherein modifying the display of the symbols further comprises changing another visual characteristic of the symbols.

5. A method as claimed in claim 4, wherein the visual characteristic is one or both of color or shape.

6. A method as claimed in claim 1, wherein the symbols are playing cards.

7. A method as claimed in claim 6, wherein the selected and non-selected cards are modified to alter the display of held cards relative to discard cards in a poker game.

8. A gaming system comprising:
a display;
a player hand selector arranged to select a plurality of symbols to form a player hand for display on the display;
a symbol selector operable by a player to select one or more symbols of the player hand; and
a hand display modifier arranged to modify the display of at least part of the player hand so that the size of each selected symbol is different to each non-selected symbol to assist a player to distinguish selected and non-selected symbols within the player hand.

9. A gaming system as claimed in claim 8, wherein the hand display modifier is arranged to modify display of the selected symbols.

10. A gaming system as claimed in claim 8, wherein the hand display modifier is arranged to modify display of the non-selected symbols.

11. A gaming system as claimed in claim 8, wherein the hand display modifier is arranged to modify the display of the symbols by changing another visual characteristic of the symbols.

12. A gaming system as claimed in claim 11, wherein the visual characteristic is one or both of color or shape.

13. A gaming system as claimed in claim 8, wherein the symbols are playing cards.

14. A gaming system as claimed in claim 13, wherein the selected and non-selected cards are modified to alter the display of held cards relative to discard cards in a poker game.

15. A gaming system as claimed in claim 8, comprising a processor and a memory storing program code which when executed by the processor implements the player hand selector and the hand display modifier.

16. A gaming system as claimed in claim 8, wherein the symbol selector comprises at least one of a touch screen and one or more buttons.

17. A player interface for a gaming system comprising:
a display arranged to display a player hand comprising a plurality of symbols forming a player hand; and
a symbol selector operable by a player to select one or more symbols of the player hand,
whereafter display of at least part of the player hand is modified so that the size of each selected symbol is different to each non-selected symbol to assist a player to distinguish selected and non-selected symbols within the player hand.

18. A player interface as claimed in claim 17, wherein the symbol selector comprises at least one of a touch screen and one or more buttons.

19. Computer program code which when executed by a computer implements a computer implemented method of gaming comprising:
displaying to a player, a player hand comprising a plurality of symbols;
receiving a player selection of one or more symbols of the player hand; and
modifying the display of at least part of the player hand so that the size of each selected symbol is different to each non-selected symbol to assist a player to distinguish selected and non-selected symbols within the player hand.

20. A computer readable medium comprising the program code of claim 19.

21. A data signal comprising the program code of claim 19.

22. Transmitting the program code of claim 19.
